(19) United States
(12) Patent Application Publication
(10) Pub. No.: US 2002/0145510 A1
(43) Pub. Date: Oct. 10, 2002

(54) SOUNDING-BODY DRIVING CIRCUIT AND OPERATING SOUND GENERATING APPARATUS USING THE SAME

(76) Inventors: HAJIME KITAMURA, SHIZUOKA-SHI (JP); NAOHIRO FUJINAMI, SHIZUOKA-SHI (JP); KATSUYOSHI OMORI, SHIZUOKA-SHI (JP)

Correspondence Address: WENDEROTH, LIND & PONACK, L.L.P., 2033 K STREET N. W., SUITE 800, WASHINGTON, DC, 20006-1021, US

(21) Appl. No.: 09/344,496

(22) Filed: Jun. 25, 1999

(30) Foreign Application Priority Data
Apr. 9, 1999 (JP) 11-102182

(51) Int. Cl. G08B 3/10

(52) U.S. Cl. 340/384.71; 340/384.1; 340/475

(57) ABSTRACT

Upon receipt of a direction indication control signal s11, a sounding-body driving circuit 12 generates a driving signal s16 for generating a flashing operation sound which is an artificial striking sound similar to a striking sound of a mechanical relay and outputs the driving signal s16 to a speaker 16 via an amplifier 14, and the flashing operation sound is outputted from the speaker 16, thereby obtaining the flashing operation sound which does not sound unusual to the driver. The sounding-body driving circuit 12 has a construction such that a plurality of rectangular wave signals having the same amplitude and different frequencies are synthesized in sequence of time by first and second synthetic signal generating circuits 20A and 20B to thus generate first and second synthetic signals s14 and s15 as artificial striking sounds, and the signals s14 and s15 are alternately outputted as driving signals s16 from a synthetic signal output circuit 22 at intervals of a predetermined time. The flashing operation sound is thus obtained with a simple and inexpensive construction.

### BACKGROUND OF THE INVENTION

1. Field of the Invention

The present invention relates to a sounding-body driving circuit outputting to a sounding body a drive signal for generating an artificial striking sound similar to a striking sound of a mechanical relay, and to an operating-sound generating apparatus using the circuit.

2. Description of the Related Art

A direction indicating apparatus of a vehicle generally has a mechanical relay for flashing a turn signal indicator, which is flashed by the mechanical relay in accordance with operation of a turn signal lever. Further, a driver of the vehicle can recognize that the turn signal indicator is in a state of flashing by means of both a visual warning of the flashing display of the indicator and an audio warning of the striking sound of the mechanical relay.

The mechanical relay is generally disposed near the driver's seat so that the driver can hear the striking sound. In the case where the mechanical relay is miniaturized, or disposed in the engine room for circuit construction reasons, it becomes hard for the driver to hear the striking sound of the mechanical relay. When the flashing operation of the turn signal indicator is performed using a semiconductor switch and the like, the mechanical relay itself is not unnecessary, with the result that the striking sound of the mechanical relay is not generated.

On the other hand, as disclosed in Japanese Unexamined Utility Model Publications JP-U 59-102448(1984) and JP-U 4-136948(1992), in the case of adopting such a construction that a sounding body such as a piezoelectric buzzer or a speaker is used and driven to generate a sound synchronized with the flashing operation of the turn signal indicator, the flashing operation state of the turn signal indicator can be notified auditorially to the driver without the striking sound of the mechanical relay.

However, since the striking sound of the mechanical relay has been used for a long time as a flashing operation sound of the turn signal indicator, drivers are accustomed to such a tone. Accordingly, in the case where only a sound different from a striking sound is generated as a flashing operation sound from the sounding body, as disclosed in the publications, such a problem occurs that the drivers have a unusual feeling because the flashing operation sound is fairly different in tone from the accustomed striking sound of the mechanical relay.

In the case of reproducing the striking sound of the mechanical relay faithfully, as shown in FIG. 9, it is necessary to generate a driving signal having an irregular waveform 4 showing a complicated envelop 2. There is consequently a problem such that the driving circuit is complicated and expensive.

### SUMMARY OF THE INVENTION

It is an object of the invention to provide a sounding-body driving circuit and operation sound generating apparatus which allow generation of a flashing operation sound of a turn signal indicator with a simple and low-cost construction without giving a unusual feeling to a vehicle driver.

In view of the fact that even if the striking sound of a mechanical relay is not reproduced faithfully, in the case where an artificial striking sound similar to the striking sound is obtained as the flashing operation sound of the turn signal indicator, the driver has no unusual feeling toward the artificial striking sound, the object of the invention is achieved by adopting a driving circuit for generating the artificial striking sound and putting some constructional thought into designing the driving circuit.

According to the invention, there is provided a sounding-body driving circuit outputting to a sounding body a driving signal for generating an artificial striking sound similar to a striking sound of a mechanical relay,

the sounding-body driving circuit generating a plurality of signals having different frequencies, synthesizing the plurality of signals in sequence of time and repeatedly outputting the generated synthetic signal at intervals of a predetermined time.

No restriction is placed on the plurality of signals in respect of frequency, waveform, amplitude etc. as long as they are different in frequency. For example, in respect of waveform, any wave such as a rectangular wave, sine wave, triangular wave or the like may be used, and in respect of amplitude a constant value may be set or different values may be set at random or according to differences in frequency between the signals.

There is no particular restriction on a specific method of synthesizing the plurality of signals in sequence of time (e.g., order of synthesis of the signals, wave number of each signal, a method of combining the signals).

The synthetic signal denotes a signal obtained by connecting in sequence of time at least two kinds of signals of different frequencies. A synthetic signal may be generated by forming two or more kinds of signals of frequencies by a single oscillation circuit and connecting the signals in sequence of time.

As shown in the construction mentioned above, the sounding-body driving circuit according to the invention outputs the driving signal for generating an artificial striking signal to the sounding body. Since the plurality of signals having different frequencies are generated and synthesized in sequence of time and the synthetic signal thus generated is repeatedly outputted at intervals of a predetermined time, the following effects can be obtained.

Various tones can be obtained by synthesizing a plurality of signals having different frequencies, such various tones cannot be obtained by signals of a single frequency. The synthesis is performed in sequence of time so that the plurality of signals are properly arranged to generate a synthetic signal and the synthetic signal is outputted to the sounding body, thereby realizing an artificial striking sound similar to the striking sound of the mechanical relay. Moreover, since the synthetic signal is repeatedly outputted at intervals of a predetermined time, by adjusting the predetermined time to a proper value, not only the tone of the artificial striking sound but also the generation interval can be made similar to those of the flashing operation sound of the turn signal indicator, that is, the striking sound of the mechanical relay.

According to the invention, a plurality of signals having different frequencies are generated and synthesized in sequence of time (that is, simply connected on a base of time), thereby realizing an artificial striking sound similar to the striking sound of the mechanical relay with a simple and low-cost construction. By repeatedly outputting the synthetic signal at intervals of a predetermined time, the flashing operation sound of the turn signal indicator which does not sound unusual to the driver can be obtained.

Although there is no specific restriction on the duration of the synthetic signal of the invention, since the duration of the striking sound of the mechanical relay is about 12 ms, it is preferable to set the duration to 12 ms or less, more preferably 6 ms or less. It is generally said in connection with the sense of hearing of humans that a duration of 1 ms or more is necessary to identify the tone of the sound, a duration of 10 ms or more to have sequential feeling, and a duration of 100 ms or more to perceive the order of time. When the duration of the synthetic signal is set to be longer than required, the sound becomes similar to an electronic sound rather than similar to the striking sound of the mechanical relay. It is preferable to set the duration of the synthetic signal rather short to such an extent that the sequential feeling of the sound is not perceived.

As long as the sounding-body driving circuit is constructed to generate a plurality of signals having different frequencies, synthesize the plurality of signals in sequence of time, and repeatedly output the generated synthetic signal at intervals of a predetermined time, the signal process may be performed in a software or hardware manner. A specific construction of the latter manner is, for example, a construction comprising a signal generating circuit for generating a plurality of signals having different frequencies, a signal synthesizing circuit for synthesizing the plurality of signals generated by the signal generating circuit in sequence of time, and a synthetic signal output circuit for repeatedly outputting the synthetic signals generated by the signal synthesizing circuit at intervals of a predetermined time.

In the construction mentioned above, by generating two kinds of synthetic signals and alternately outputting them, the following effects can be obtained.

In general there are two kinds of striking sounds of the mechanical relay. One striking sound generates when the movable piece of the mechanical relay comes into contact with the iron core and the other striking sound generates when the movable piece comes into contact with a contact point. The two kinds of the striking sounds are alternately generated to make the flashing operation sound of the turn signal indicator of a vehicle. It is therefore preferable to make the artificial sounds similar to the two kinds of striking sounds. When the two kinds of synthetic signals are generated and alternately outputted, an artificial striking sound can be generated at the tone similar to the flashing operation sound which is an actual striking sound of the mechanical relay.

In this case, as long as the two kinds of synthetic signals are different from each other, there is no specific restriction on their construction. For example, a plurality of signals constructing the synthetic signal may be different in only any one of frequency component, duration and amplitude or two or three thereof.

Although the sounding-body driving circuit according to the invention has the construction suitable for obtaining the flashing operation sound of a turn signal indicator of a vehicle as mentioned above, there is no restriction on the circuit in respect of use. The circuit can be generally used for the case where it is necessary or preferable to generate an artificial striking sound similar to the striking sound of the mechanical relay.

In a use other than the use of obtaining the flashing operation sound, there may be a case where the synthetic signal does not have to be repeatedly outputted at intervals of a predetermined time. From the point of view, a sufficient technical value can be found also in the construction as the sounding-body driving signal generating circuit for generating a plurality of signals having different frequencies and synthesizing the plurality of signal in sequence of time. That is, since the sounding-body driving signal for generating the artificial striking sound similar to the striking sound of the mechanical relay can be obtained by the synthetic signal generated by the sounding-body driving signal generating circuit, when the sounding-body driving signal is outputted to the sounding body at proper timing, an artificial striking sound adapted to the generation pattern of the striking sound of the mechanical relay used for various uses can be generated.

On the other hand, when the sounding-body driving circuit according to the invention is constructed as a part of the operating-sound generating apparatus of the turn signal indicator, the synthetic signal is outputted synchronously with the timing of the turn-on and turn-off of the turn signal indicator. The artificial striking sound can be generated at the same timing as the generation timing of the flashing operation sound which is the striking sound of the mechanical relay, so that it can be more effectively prevented that the driver feels the sound unusual.

When the sounding-body driving circuit is constructed as a part of the operation sound generating apparatus of the turn signal indicator, by adopting the construction of generating two kinds of signals and alternately outputting the two kinds of signals synchronously with the timing of the turn-on and turn-off of the turn signal indicator, the flashing operation sound of the turn signal indicator, which does not sound unusual to the driver can be obtained.

By alternately outputting the two kinds of signals, two kinds of artificial striking sounds are alternately generated from the sounding body. Even if each artificial striking sound itself is not similar to the striking sound of the mechanical relay, a synthetic signal obtained by synthesizing a plurality of signals having different frequencies is not used as the driving signal and the generation pattern of the artificial striking sound is the same as that of the flashing operation sound of the turn signal indicator by the striking sound of the mechanical relay, so that it can be prevented that the flashing operation sound of the turn signal indicator sounds unusual to the driver. By adopting such a construction, the sounding-body driving circuit can be constructed simpler at lower cost.

In the operation sound generating apparatus of the turn signal indicator having the sounding-body drive circuit and the sounding body, the flashing operation sound of the turn signal indicator which does not sound unusual to the driver can be obtained as mentioned above. Using the sounding body of the operation sound generating apparatus, sounds other than the flashing operation sound can be also generated. That is, by adding proper driving means, the function of warning a failure in the direction indicating apparatus (for example, burn-out of a bulb in the turn signal indicator), a failure in other apparatuses mounted on the vehicle, and the like can be provided.

### BRIEF DESCRIPTION OF THE DRAWINGS

Other and further objects, features, and advantages of the invention will be more explicit from the following detailed description taken with reference to the drawings wherein:

FIG. 1 is a block diagram showing an operation sound generating apparatus according to an embodiment of the invention;

FIG. 2 is a time chart showing the operation of a sounding-body driving circuit in the operation sound generating apparatus;

FIG. 3 is a diagram showing waveforms of first and second synthetic signals generated by first and second synthetic signal generating circuits in the sounding-body driving circuit;

FIG. 4 is a block diagram showing the construction of the first synthetic signal generating circuit;

FIG. 5 is a time chart showing the operation of the first synthetic signal generating circuit;

FIGS. 6A to 6C are waveform charts showing waveform data of a striking sound of a mechanical relay and an artificial striking sound which were actually measured together with the waveform of an artificial striking sound driving signal on the same time base;

FIG. 6D is a graph showing the frequency characteristics of a speaker which generated the artificial striking sound illustrated in FIG. 6C;

FIGS. 7A to 7C are diagrams showing modifications of the first and second synthetic signals;

FIG. 8 is a diagram showing a modification of the foregoing embodiment; and

FIG. 9 is a waveform chart showing an example of a driving signal to faithfully reproduce the striking sound of the mechanical relay.

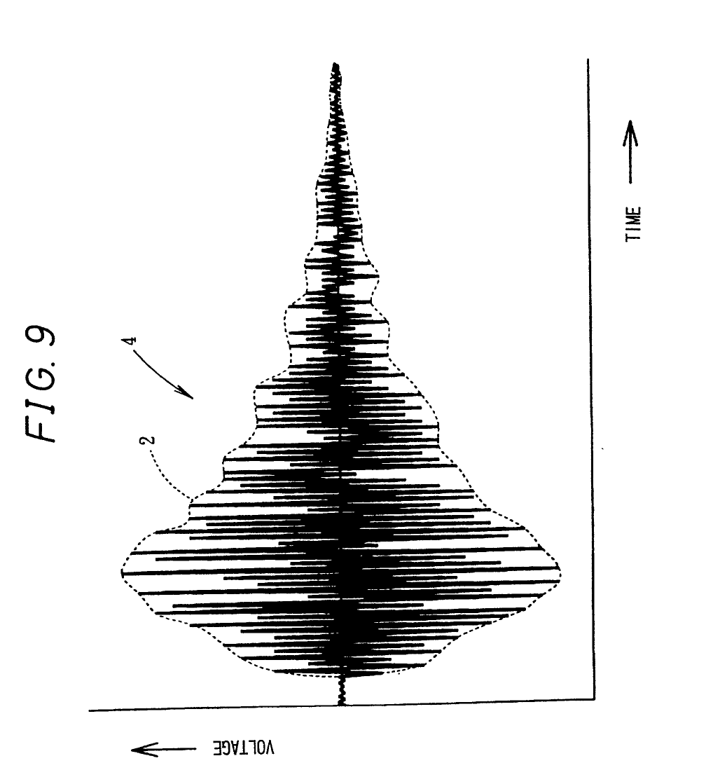

### DETAILED DESCRIPTION OF THE PREFERRED EMBODIMENTS

Now referring to the drawings, preferred embodiments of the invention are described below.

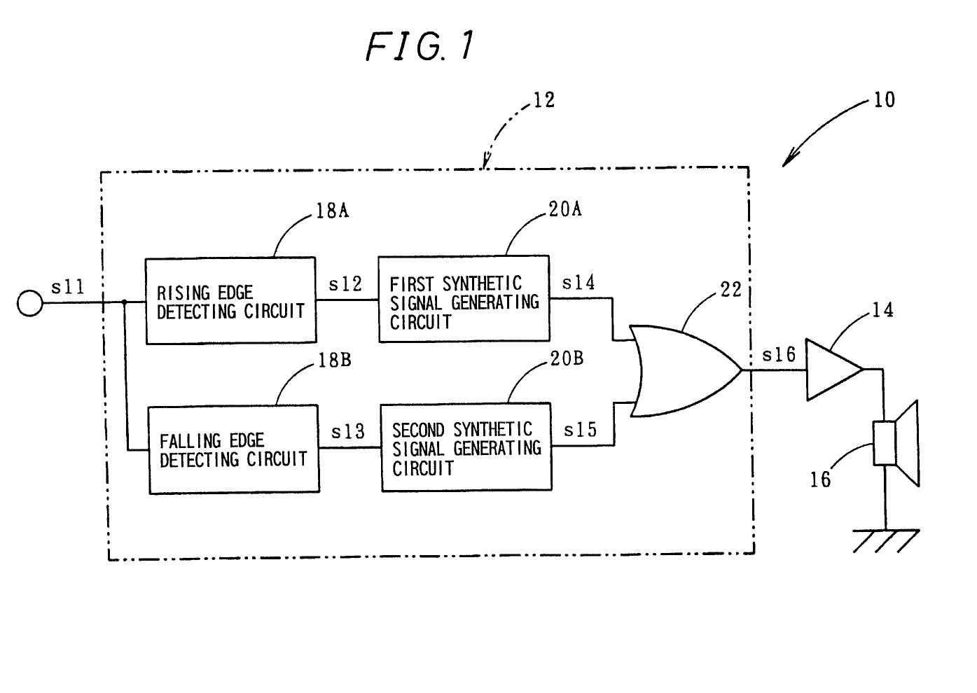

FIG. 1 is a block diagram showing an operation sound generating apparatus 10 according to an embodiment of the invention.

The operation sound generating apparatus 10 constructs a part of a direction indicating apparatus of a vehicle and comprises a sounding-body driving circuit 12, an amplifier 14, and a speaker 16 (sounding body). The operation sound generating apparatus 10 repeatedly generate an artificial striking sound similar to the striking sound of the mechanical relay at intervals of a predetermined time, as a flashing operation sound of the turn signal indicator.

More specifically, in the operation sound generating apparatus 10, a direction indication control signal s11 for making a turn signal indicator (not shown) flash is supplied to the sounding-body driving circuit 12. A driving signal s16 for causing the flashing operation sound is generated by the sounding-body driving circuit 12 and is outputted to the amplifier 14. The driving signal s16 is power-amplified by the amplifier 14 and the amplified signal is outputted to the speaker 16. The flashing operation sound is outputted from the speaker 16.

The sounding-body driving circuit 12 comprises a leading edge detecting circuit 18A and a trailing edge detecting circuit 18B disposed in parallel, a first and a second synthetic signal generating circuits 20A and 20B connected to the detecting circuits 18A and 18B, respectively, and a synthetic signal output circuit 22 connected to the first and second synthetic signal generating circuits 20A and 20B.

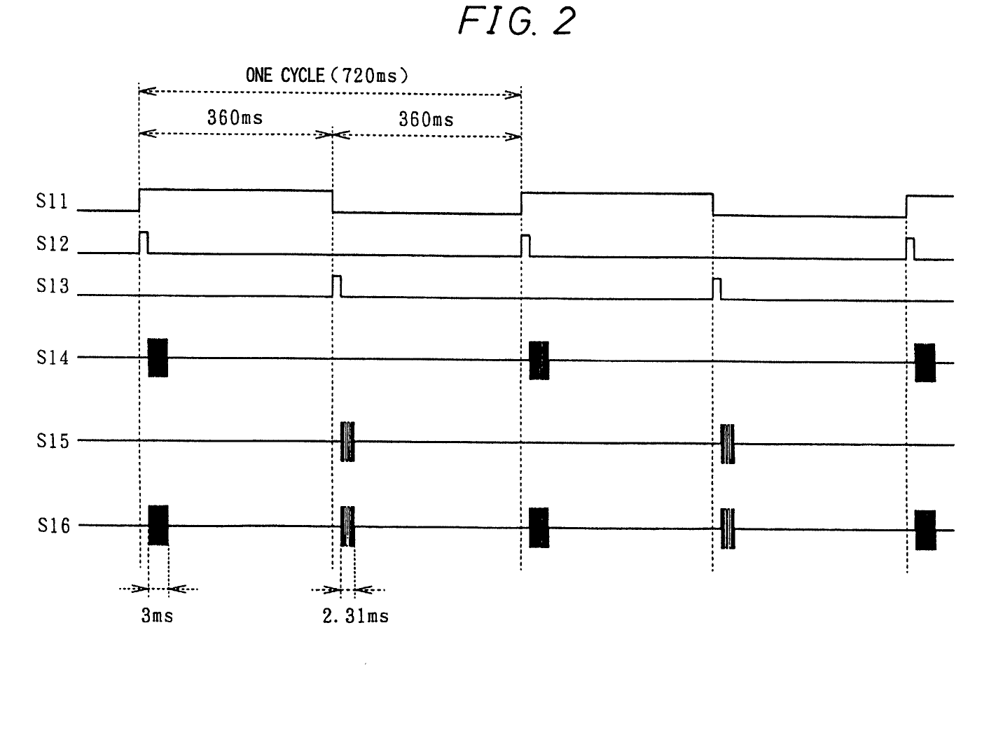

A specific construction of the sounding-body driving circuit 12 will now be described according to the time chart shown in FIG. 2.

The direction indication control signal s11 is supplied to the leading edge detecting circuit 18A and the trailing edge detecting circuit 18B. The direction indication control signal s11 is a binary signal in which on-time of 360 ms and off-time of 360 ms are repeated and the turn signal indicator is turned on in on-time. The leading edge detecting circuit 18A detects the timing of the leading edge of the direction indication control signal s11, generates a rectangular pulse signal s12 having a narrow pulse width at the leading timing and outputs the signal s12 to the first synthetic signal generating circuit 20A. On the other hand, the trailing edge detecting circuit 18B detects the trailing timing of the direction indication control signal s11, generates a rectangular pulse signal s13 having a narrow pulse width at the trailing timing, and outputs the signal s13 to the second synthetic signal generating circuit 20B.

The first synthetic signal generating circuit 20A generates a first synthetic signal s14 (which will be described hereinlater) at the trailing timing of the rectangular pulse signal s12 and outputs the signal s14 to the synthetic signal output circuit 22. On the other hand, the second synthetic signal generating circuit 20B generates a second synthetic signal s15 (which will be described hereinlater) at the trailing timing of the rectangular pulse signal s13 and outputs the signal s13 to the synthetic signal output circuit 22.

The synthetic signal output circuit 22 adds the first and second synthetic signals s14 and s15 supplied from the first and second synthetic signal generating circuits 20A and 20B and outputs the calculation result as the drive signal s16 to the amplifier 14. The driving signal s16 is an intermittent signal such that the first and second synthetic signals s14 and s15 are alternately repeatedly outputted synchronously with timing of the turn-on and the turn-off of the turn signal indicator. There is no signal between the first and second synthetic signals s14 and s15. The reason why the first and second synthetic signals s14 and s15 are alternately outputted as the driving signals sl6 is to obtain a flashing operation sound comprised of artificial striking sounds similar to two kinds of striking sounds (that is, a striking sound when a movable piece comes into contact with an iron core and a striking sound when the movable piece comes into contact with the contact point) generated by the mechanical relay.

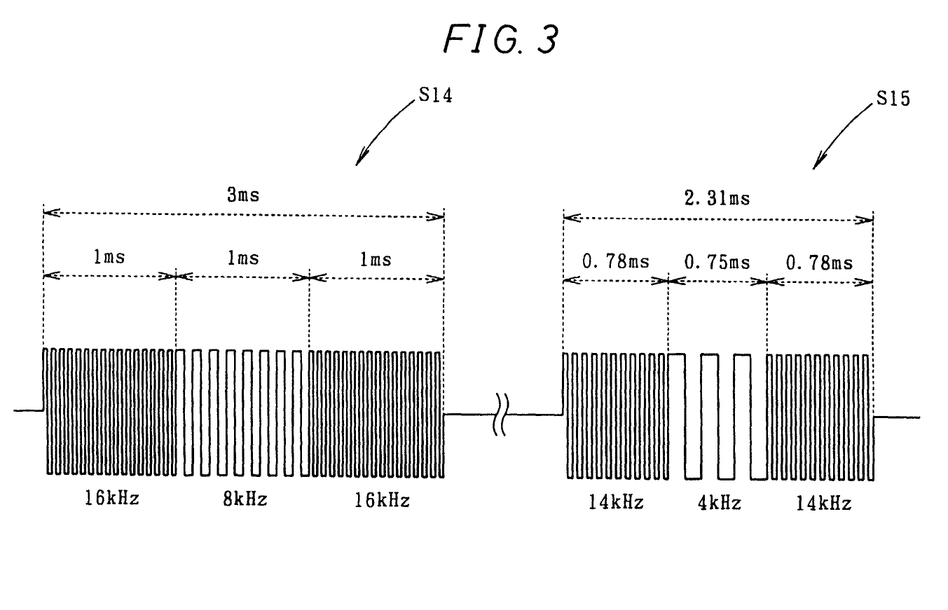

FIG. 3 shows the waveforms of the first and second synthetic signals s14 and s15.

As shown in the diagram, each of the first and second synthetic signals s14 and s15 is obtained by synthesizing a plurality of rectangular wave signals having the same amplitude and different frequencies in sequence of time. The duration of each of the signals s14 and s15 is set to a very short value. Specifically, the first synthetic signal s14 is a signal whose duration is 3 ms in which rectangular wave signals having a frequency of 16 kHz, rectangular wave signals having a frequency of 8 kHz, and rectangular wave signals having a frequency of 16 kHz each having the duration of 1 ms are successively simply connected on the time base. On the other hand, the second synthetic signal s15 is a signal whose duration is 2.31 ms in which rectangular wave signals having a frequency of 14 kHz, rectangular wave signals having a frequency of 4 kHz, and rectangular wave signals having a frequency of 14 kHz whose durations are 0.78 ms, 0.75 ms, and 0.78 ms, respectively, are successively simply connected on the time base. The duration of the rectangular wave signal constructing each synthetic signal is set to a very short time so that the human ear cannot identify the rectangular wave signals as different sounds. As a result, they are recognized as a single sound by the human ear.

Since the constructions of the first and second synthetic signal generating circuits 20A and 20B for generating the first and second synthetic signals s14 and s15 are substantially the same, only the construction of the first synthetic signal generating circuit 20A will be described specifically.

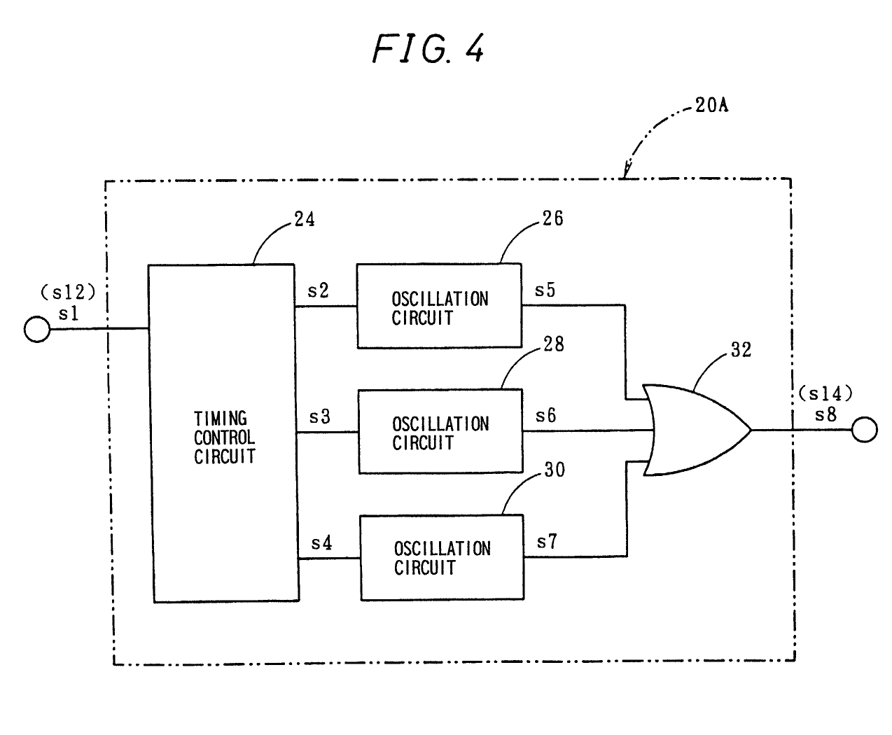

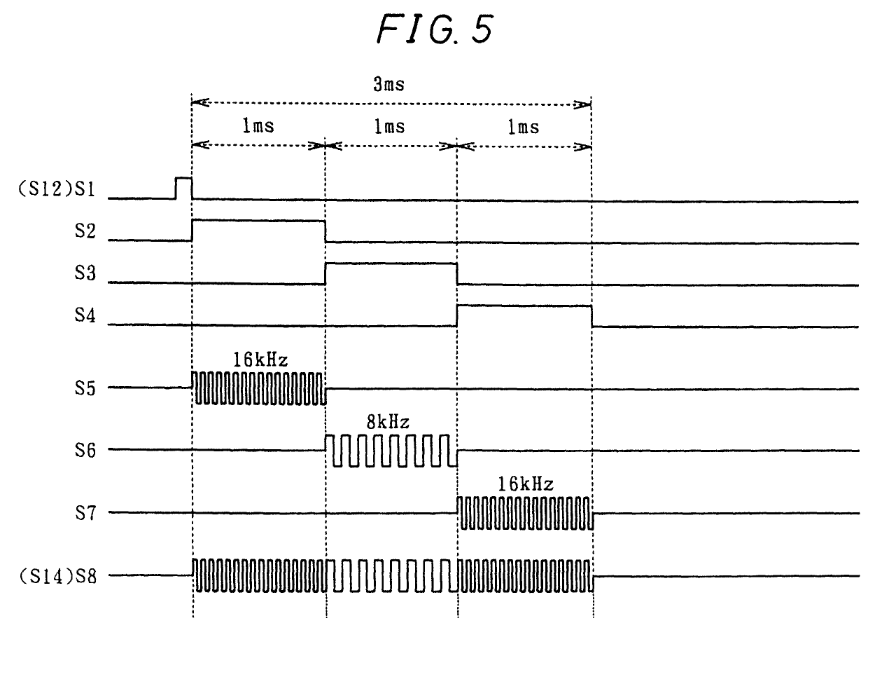

FIG. 4 is a block diagram showing the construction of the first synthetic signal generating circuit 20A and FIG. 5 is a time chart showing the operation of the circuit 20A.

As shown in FIG. 4, the first synthetic signal generating circuit 20A comprises a timing control circuit 24, three oscillation circuits (signal generating circuits) 26, 28, and 30, and a signal synthesizing circuit 32.

The timing control circuit 24 generates trigger signals s2, s3, and s4 to operate the oscillation circuits 26, 28, and 30 on the basis of the inputted rectangular pulse signal s1 (that is, the rectangular pulse signal s12 supplied from the leading edge detecting circuit 18A) and outputs the trigger signals s2, s3, and s4 to the oscillation circuits 26, 28, and 30, respectively. The trigger signal s2 is a rectangular pulse signal having the pulse width of 1 ms generated at the trailing timing of the rectangular pulse signal s1. The trigger signal s3 is a rectangular pulse signal having the pulse width of 1 ms generated at the trailing timing of the rectangular pulse signal s2. The trigger signal s4 is a rectangular pulse signal having the pulse width of 1 ms generated at the trailing timing of the rectangular pulse signal s3.

The oscillation circuit 26 oscillates a rectangular wave signal s5 of the frequency of 16 kHz for the period of the pulse width 1 ms of the trigger signal s2 by the input of the trigger signal s2. The oscillation circuit 28 oscillates a rectangular wave signal s6 of the frequency of 8 kHz for the period of the pulse width 1 ms of the trigger signal s3 by the input of the trigger signal s3. The oscillation circuit 30 oscillates a rectangular wave signal s6 of the frequency of 16 kHz for the period of the pulse width 1 ms of the trigger signal s4 by the input of the trigger signal s4.

The signal synthesizing circuit 32 adds the rectangular wave signals s5, s6, and s7 supplied from the three oscillation circuits 26, 28, and 30, generates a synthetic signal s8 (that is, the first synthetic signal s14) as a calculation result, and outputs the synthetic signal s8 to the synthetic signal output circuit 22.

On the other hand, the second synthetic signal generating circuit 20B has the same construction as that of the first synthetic signal generating circuit 20A except for the pulse widths of the trigger signals s2, s3, and s4 generated by the timing control circuit 24 and the oscillation frequencies of the oscillation circuits 26, 28, and 30.

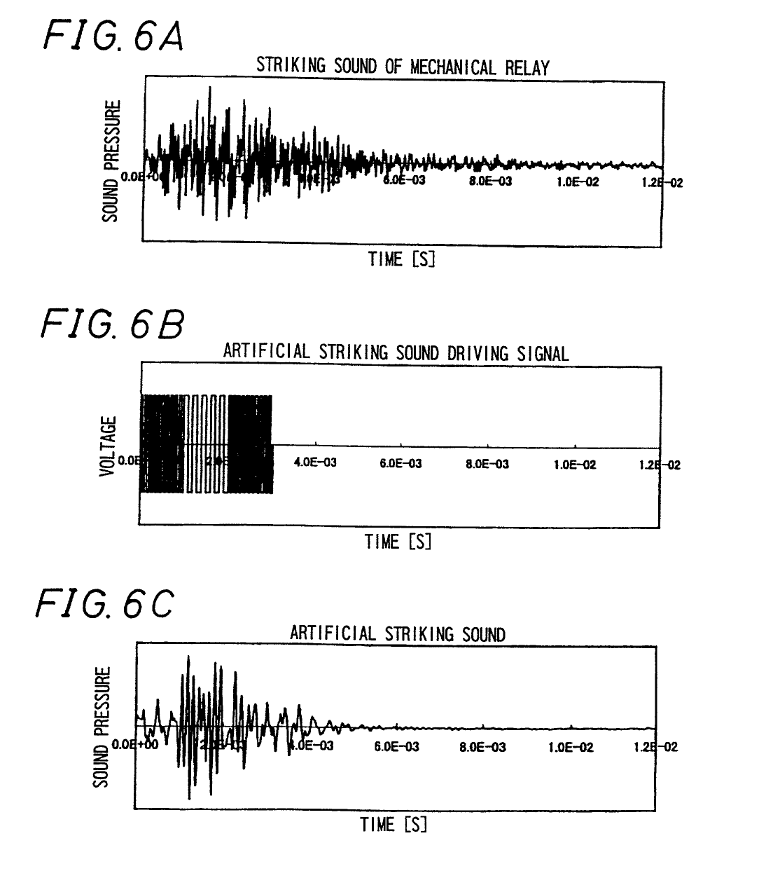

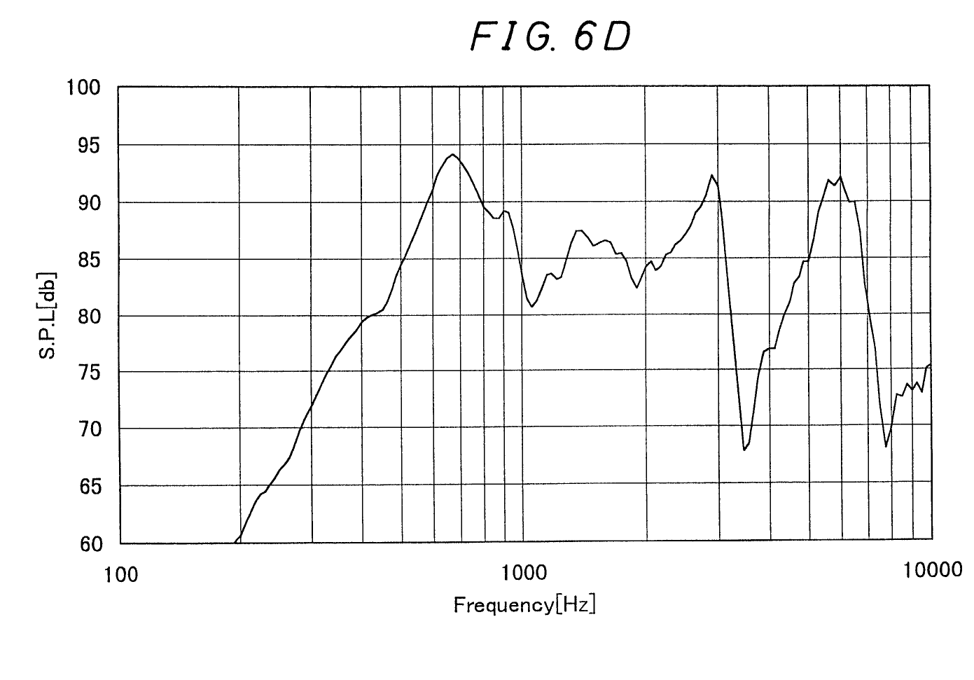

FIGS. 6A to 6C are waveform charts showing waveform data of the striking sound of the mechanical relay and an artificial striking sound which were actually measured together with the waveform of a driving signal (artificial striking sound driving signal) for generating an artificial striking sound on the same time base. One scale of the time base is 2 ms.

The waveform data shown in FIG. 6A is waveform data obtained through a microphone by actually operating the direction indicating apparatus of a vehicle to generate a flashing operation sound of the turn signal indicator and acquiring one of two kinds of striking sounds generated by a mechanical relay. The waveform shown in FIG. 6B is a waveform of the artificial striking sound driving signal (in this case, the synthetic signal s8 is used) produced to generate an artificial striking sound similar to the striking sound. The waveform data shown in FIG. 6C is waveform data obtained through a microphone from an artificial striking sound generated from the speaker 16 by the artificial striking sound driving signal. The speaker 16 used for an experiment is a dynamic microspeaker having an rated input of 0.2W and its diaphragm, made of a Mylar film material, has the diameter of 28 mm. The frequency characteristics are shown in FIG. 6D. The vertical axis denotes a sound pressure level (dB) and the lateral axis denotes the logarithm of the frequency.

As illustrated, the waveform of the artificial striking sound can be made quite similar to that of the striking sound of the mechanical relay, using the synthetic signal s8 as an artificial striking sound driving signal. In this case, by setting the composition of the artificial striking sound driving signal in consideration of the frequency characteristics and the mechanical attenuation characteristics peculiar to the speaker 16, the waveform of the artificial striking sound can be made similar to that of the striking sound of the mechanical relay. In the case where a speaker different in characteristics, it is sufficient to properly change the composition of the artificial striking sound driving signal in accordance with the characteristics of the speaker.

As described specifically above, the operation sound generating apparatus 10 according to the embodiment is constructed so that the driving signal s16 for generating the flashing operation sound which is the artificial striking sound similar to the striking sound of the mechanical relay is generated by the sounding-body driving circuit 12 and the driving signal s16 is repeatedly outputted to the speaker 16 via the amplifier 14 at intervals of a predetermined time. Consequently, the flashing operation sound of the turn signal indicator which does not sound unusual to the driver can be obtained.

Moreover, since the driving signal s16 from the sounding-body driving circuit 12 is outputted by alternately outputting the first and second synthetic signals s14 and s15 having different frequency components generated by the first and second synthetic signal generating circuits 20A and 20B, the artificial striking sounds similar to the two kinds of the striking sounds generated by the mechanical relay can be generated. Thus, the flashing operation sound comprised of the artificial striking sounds of the tone which is closer to the striking sound of the mechanical relay can be obtained.

Further, since the first and second synthetic signals s14 and s15 are generated synchronously with the direction indication control signals s11 from the leading edge detecting circuit 18A and the trailing edge detecting circuit 18B, the interval of generation of the artificial striking sounds can be made the same as that of the flashing operation sounds of the turn signal indicator, which is the striking sound of the mechanical relay. Consequently, it can be effectively prevented that the striking sound does not sound unusual to the driver.

Since the first and second synthetic signal generating circuits 20A and 20B generate the first and second synthetic signals s14 and s15 by synthesizing a plurality of rectangular wave signals having the same amplitude and different frequencies in sequence of time, the artificial striking sound can be obtained with a simple and inexpensive construction. Moreover, by the harmonic components included in the plurality of rectangular wave signals, the artificial striking sound can be made further closer to the striking sound of the mechanical relay having wide-ranged frequency components. The driving signal s16 generated as mentioned above was supplied to the speaker 16 and its sound was compared with the actual relay operation sound of the direction indicator of a vehicle. As a comparison result by ten persons, all of them determined that the sounds are quite similar.

Although the sounding-body driving circuit 12 generates and outputs the driving signal s16 by the hardware construction in the embodiment, the driving signal s16 may be also generated and outputted by a software control using a microcomputer or the like.

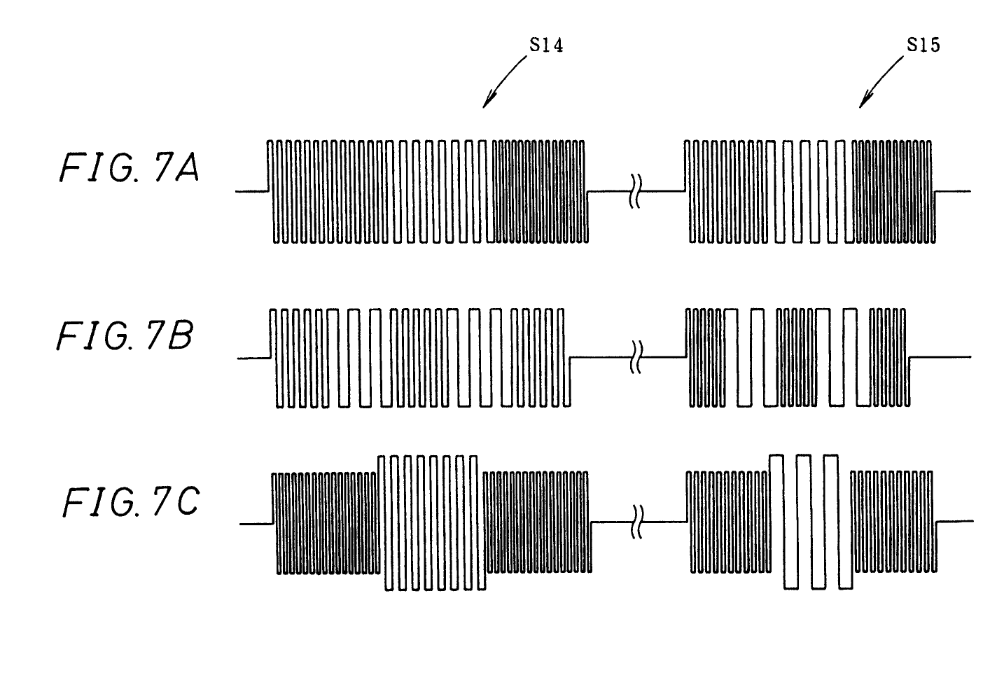

Although the case where the three rectangular wave signals s5, s6, and s7 constructing the first and second synthetic signals s14 and s15 have the same amplitude and their frequencies are arranged in the order of high—low—high has been described in the foregoing embodiment, as shown in FIGS. 7A and 7B, the frequency components of the rectangular wave signals may be changed as appropriate in accordance with the frequency characteristics of the speaker 16 and the like and the amplitudes of the rectangular wave signals may be set to different values as shown in FIG. 7C. An artificial striking sound which is further closer to the striking sound of the mechanical relay can be thus obtained.

As mentioned above, not only the rectangular wave but also triangular wave or sine wave can be also used as the signal waveform. In the case of using the other waveform, the oscillation circuits 26, 28, and 30 in FIG. 4 are replaced to oscillation circuits for triangular wave or sine wave and an operational amplifier or an analog switch may be used as the signal synthesizing circuit 32.

Although the rectangular wave signals s5, s6, and s7 are synthesized without any pause in the foregoing embodiment, pauses may be made between rectangular wave signals. In this case, the pause is desirably n/2 (n is an integer) of each signal cycle.

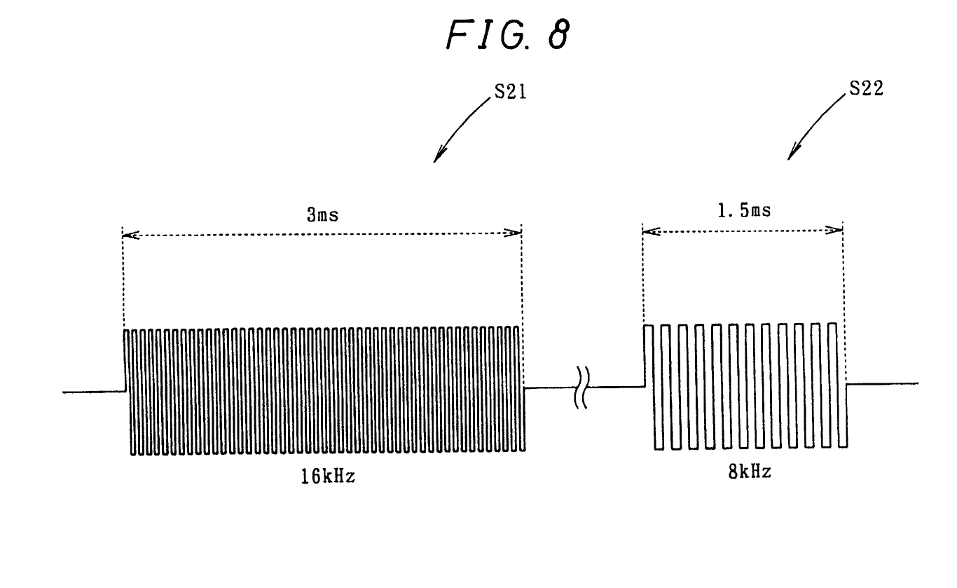

Further, in the embodiment, the first and second synthetic signal generating circuits 20A and 20B generate the first and second synthetic signals s14 and s15 by synthesizing a plurality of rectangular wave signals having different frequencies. In place of the first and second synthetic signal generating circuits 20A and 20B, for example, first and second signal generating circuits for generating first and second rectangular wave signals s21 and s22 having different frequencies and different durations as shown in FIG. 8 can be also used.

In the case of adopting such a construction, two kinds of the rectangular wave signals s21 and s22 generated by the first and second signal generating circuits are alternately outputted from a signal output circuit replacing the synthetic signal output circuit 22 synchronously with the timing of the turn-on and turn-off of the turn signal indicator and two kinds of artificial striking sounds are alternately generated from the speaker 16. Even if each of the artificial striking sounds is not similar to the striking sound of the mechanical relay, since the generation pattern of the artificial striking sound is the same as that of the flashing operation sound of the turn signal indicator which is the striking sound of the mechanical relay, it can be prevented that the flashing operation sound of the turn signal indicator sounds unusual to the driver. By adopting such a construction, the construction of the sounding-body driving circuit can be made simpler and cheaper.

On the contrary, a synthetic signal obtained by synthesizing a plurality of rectangular wave signals having different frequencies is used as the signal itself outputted from the sounding-body driving circuit, and one kind of synthetic signals can be repeatedly outputted synchronously with the timing of the turn-on and turn-off of the turn signal indicator.

In the case of adopting such a construction, the tone of the artificial striking sound generated from the speaker 16 based on the synthetic signal can be made similar to that of at least one of the two kinds of the striking sounds generated by the mechanical relay. By generating the artificial striking sound in the same pattern as the generation pattern of the flashing operation sound of the turn signal indicator which is the striking sound of the mechanical relay, it can be prevented that the flashing operation sound of the turn signal indicator sounds unusual to the driver. By adopting the construction, it is sufficient to use a single synthetic signal generating circuit, so that the sounding-body driving circuit can have the construction further simpler and cheaper.

The first synthetic signal generating circuit 20A (or the second synthetic signal generating circuit 20B) constructing a part of the sounding-body driving circuit 12 of the embodiment is constructed so as to generate the synthetic signal s14 (or s15) used as the artificial striking sound driving signal. It can be used not only for the use of obtaining the flashing operation sound of the turn signal indicator by repeatedly generating the artificial striking sound at intervals of a predetermined time as the operation sound generating apparatus of the turn signal indicator but also in various fields where the artificial striking sound is necessary.

Although the case where the plurality of oscillation circuits are provided and the synthetic signal is generated by connecting the signals generated by the oscillation circuits in sequence of time has been described in the foregoing embodiment, it is also possible to generate a synthetic signal by generating two or more kinds of signals of frequencies by a single oscillation circuit and changing the frequencies of the signals to be generated with elapse of time.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A sounding-body driving circuit outputting to a sounding body a driving signal for generating an artificial striking sound similar to a striking sound of a mechanical relay,
wherein a plurality of signals having different frequencies are generated and synthesized in sequence of time, and the generated synthetic signal is repeatedly outputted at intervals of a predetermined time.

2. A sounding-body driving circuit outputting to a sounding body a driving signal for generating an artificial striking sound similar to a striking sound of a mechanical relay, comprising:
a signal generating circuit for generating a plurality of signals having different frequencies;
a signal synthesizing circuit for synthesizing the plurality of signals generated by the signal generating circuit in sequence of time; and
a synthetic signal output circuit for repeatedly outputting the synthetic signal generated by the signal synthesizing circuit at intervals of a predetermined time.

3. The sounding-body driving circuit of claim 1, wherein the synthetic signals are generated in two kinds of forms and alternately outputted.

4. The sounding-body driving circuit of claim 2, wherein the synthetic signals are generated in two kinds of forms and alternately outputted.

5. A sounding-body driving circuit outputting to a sounding body a driving signal for generating an artificial striking sound similar to a striking sound of a mechanical relay, comprising:
a signal generating circuit for generating at least two kinds of signals having different frequencies; and
a switching circuit for switching the frequency of the signal generating circuit at very short intervals.

6. A sounding-body driving signal generating circuit for generating a sounding-body driving signal for generating an artificial striking sound similar to a striking sound of a mechanical relay,
wherein a plurality of signals of different frequencies are generated and synthesized in sequence of time.

7. The sounding-body driving circuit of claim 1, being constructed as a part of an operation-sound generating apparatus of a turn signal indicator, for outputting the synthetic signal synchronously with timing of turn-on and turn-off of the turn signal indicator.

8. The sounding-body driving circuit of claim 2, being constructed as a part of an operation-sound generating apparatus of a turn signal indicator, for outputting the synthetic signal synchronously with timing of turn-on and turn-off of the turn signal indicator.

9. A sounding-body driving circuit being constructed as a part of an operation sound generating apparatus of a turn signal indicator, for outputting to a sounding body a driving signal for generating an artificial striking sound similar to a striking sound of a mechanical relay,
wherein the circuit generates two kinds of signals and alternately outputs the signals synchronously with timing of turn-on and turn-off of a turn signal indicator.

10. An operation sound generating apparatus of a turn signal indicator, comprising:
the sounding-body driving circuit of claim 1; and
a sounding body for generating the artificial striking sound upon receipt of the driving signal from the sounding-body driving circuit.

11. An operation sound generating apparatus of a turn signal indicator, comprising:
the sounding-body driving circuit of claim 2; and
a sounding body for generating the artificial striking sound upon receipt of the driving signal from the sounding-body driving circuit.

12. An operation sound generating apparatus of a turn signal indicator, comprising:
the sounding-body driving circuit of claim 2; and
a sounding body for generating the artificial striking sound upon receipt of the driving signal from the sounding-body driving circuit.

13. An operation sound generating apparatus of a turn signal indicator, comprising:
the sounding-body driving circuit of claim 7; and
a sounding body for generating the artificial striking sound upon receipt of the driving signal from the sounding-body driving circuit.

14. An operation sound generating apparatus of a turn signal indicator, comprising:
the sounding-body driving circuit of claim 8; and
a sounding body for generating the artificial striking sound upon receipt of the driving signal from the sounding-body driving circuit.

15. An operation sound generating apparatus of a turn signal indicator, comprising:
the sounding-body driving circuit according to claim 9; and
a sounding body for generating the artificial striking sound upon receipt of the driving signal from the sounding-body driving circuit.
